(19) United States
(12) Patent Application Publication
(10) Pub. No.: US 2025/0273916 A1
(43) Pub. Date: Aug. 28, 2025

(54) CONNECTOR

(71) Applicant: Yazaki Corporation, Tokyo (JP)

(72) Inventors: Akiyoshi TAKAGI, Shizuoka (JP); Tomoharu Suzuki, Shizuoka (JP); Takuro Shimada, Shizuoka (JP)

(73) Assignee: Yazaki Corporation, Tokyo (JP)

(21) Appl. No.: 19/052,462

(22) Filed: Feb. 13, 2025

(30) Foreign Application Priority Data
Feb. 26, 2024 (JP) 2024-026274

(51) Int. Cl. H01R 13/74

(52) U.S. Cl. CPC H01R 13/748; H01R 2201/26

(57) ABSTRACT

A connector includes: a housing; a first terminal housed in the housing; a second terminal housed in the housing and electrically connected to the first terminal; a fastening member electrically connecting the first terminal and the second terminal by fastening; and a cover assembled to the housing and covering a portion where the fastening member is arranged. The cover is provided with a detection portion that abuts against the fastening member when the fastening member is arranged at an incomplete fastening position, and prevents the cover from being assembled to the housing.

### CROSS REFERENCE TO RELATED APPLICATIONS

The present application is based on, and claims priority from the Japanese Patent Application No. 2024-026274, filed on Feb. 26, 2024, the entire contents of which are incorporated herein by reference.

### TECHNICAL FIELD

The present disclosure relates to a connector.

### BACKGROUND

A connector disclosed in JP 2020-078971 A (PTL 1) includes a housing, an inverter as a first terminal that is housed in the housing, and a bus bar as a second terminal that is housed in the housing and electrically connected to the inverter. The connector also includes a bolt as a fastening member that electrically connects the inverter and the bus bar by fastening, and a cover that is assembled to the housing and covers a portion where the bolt is arranged. In this connector, the inverter and the bus bar are brought into contact with each other by fastening the bolt to the inverter and the bus bar, thereby electrically connecting the inverter and the bus bar. A portion of the housing where the bolt is positioned is covered by the cover by assembling the cover to the housing, thereby preventing the electrical connection portion between the inverter and the bus bar from being exposed to the outside.

### SUMMARY

In the connector described in PTL 1, there have been cases in which the fastening member is not sufficiently fastened to the first terminal and the second terminal, or in which the fastening member is merely arranged but forgotten to be fastened. In the connector described in PTL 1, even if the fastening member is incompletely fastened, the cover can be assembled to the housing. For this reason, there has been a possibility that the first terminal and the second terminal are not electrically connected to each other even though the assembly of the connector is complete, thereby reducing the reliability of electrical connection in some cases.

An object of the present disclosure is to provide a connector capable of maintaining the reliability of electrical connection.

A connector according to an embodiment includes: a housing; a first terminal housed in the housing; a second terminal housed in the housing and electrically connected to the first terminal; a fastening member electrically connecting the first terminal and the second terminal by fastening; and a cover assembled to the housing and covering a portion where the fastening member is arranged. The cover is provided with a detection portion that abuts against the fastening member when the fastening member is arranged at an incomplete fastening position, and prevents the cover from being assembled to the housing.

The embodiment makes it possible to provide a connector capable of maintaining the reliability of electrical connection.

### BRIEF DESCRIPTION OF THE DRAWINGS

FIG. 1 is a perspective view of a connector according to an embodiment.

FIG. 2 is an exploded perspective view of the connector according to the embodiment.

FIG. 3 is a cross-sectional view when a fastening member of the connector according to the embodiment is completely fastened.

FIG. 4 is a side view when the fastening member of the connector according to the embodiment is completely fastened.

FIG. 5 is a cross-sectional view when the fastening member of the connector according to the embodiment is incompletely fastened.

FIG. 6 is a side view when the fastening member of the connector according to the embodiment is incompletely fastened.

FIG. 7 is a perspective view of a first housing of the connector according to the embodiment.

FIG. 8 is an exploded perspective view of the first housing of the connector according to the embodiment.

FIG. 9 is a perspective view of a second housing of the connector according to the embodiment.

FIG. 10 is an exploded perspective view of the second housing of the connector according to the embodiment.

FIG. 11 is a perspective view of a cover of the connector according to the embodiment.

FIG. 12 is an exploded perspective view of the cover of the connector according to the embodiment.

### DETAILED DESCRIPTION

Hereinafter, a connector module according to an embodiment will be described in detail with reference to the drawings. The dimensional ratios in the drawings are exaggerated for the sake of explanation and may differ from the actual ratios.

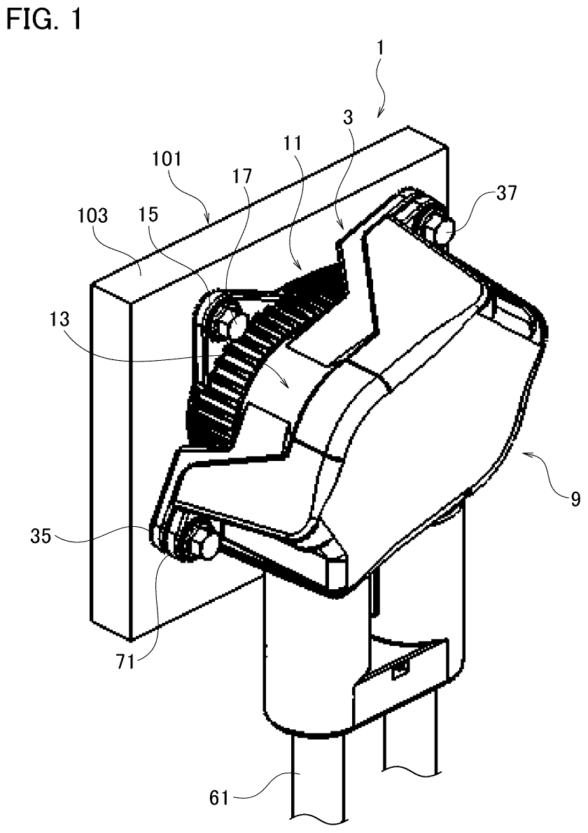

As illustrated in FIG. 1, a connector 1 according to the embodiment is applied to an electric component 101 mounted on a vehicle, for example. The connector 1 electrically connects, for example, an electric component 101 to another electric component (not illustrated), such as a power supply or a device, mounted on a vehicle. As illustrated in FIGS. 1 to 3, in the electric component 101, a mating terminal (not illustrated) is housed inside a casing 103, for example. The casing 103 is provided with an arrangement portion 105 constituted of a through-hole that is formed by penetrating through a wall where the mating terminal is arranged. The connector 1 is assembled to the arrangement portion 105, and the electric component 101 and the connector 1 are electrically connected to each other.

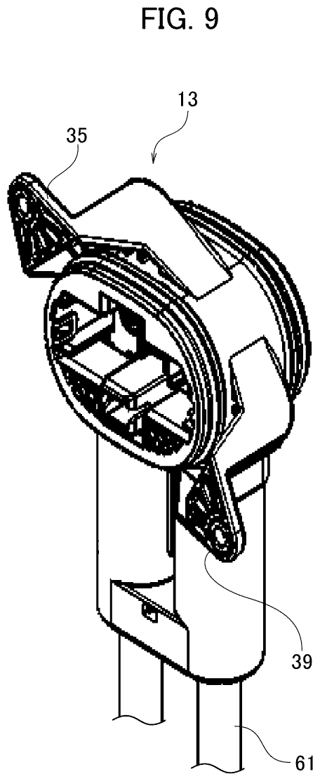

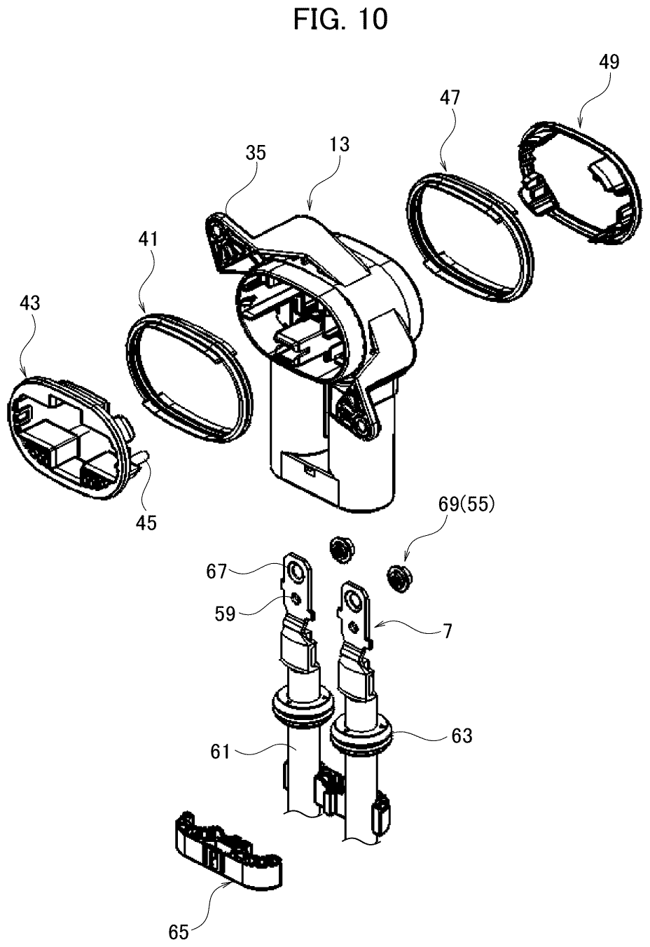

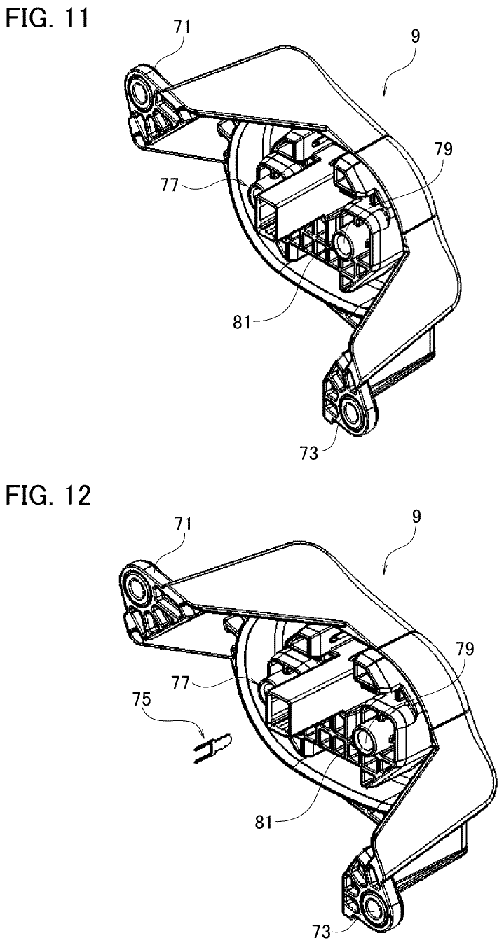

As illustrated in FIGS. 1 to 12, the connector 1 includes a housing 3, first terminals 5, second terminals 7, and a cover 9.

As illustrated in FIGS. 1 to 10, the housing 3 includes a first housing 11 and a second housing 13.

The first housing 11 is made of an insulating material such as synthetic resin, for example. As illustrated in FIGS. 1 to 8, a portion of the first housing 11 is formed into a cylindrical shape that can be inserted into the arrangement portion 105 of the electric component 101. At the outer periphery of the first housing 11, a plurality of component fixing portions 15 (two in the embodiment) projecting to an outer diameter side from the arrangement portion 105 of the electric component 101 are provided. In each component fixing portion 15, a collar 19 is insert-molded. Bolt 17 to be fastened into screw holes 107 that are provided in the casing 103 of the electric component 101 are inserted into the collars 19. On a surface of each component fixing portion 15 facing the casing 103 of the electric component 101, a positioning pin 21 to be inserted into a positioning hole 109 that is provided in the casing 103 projects toward the casing 103. The component fixing portions 15 position the first housing 11 with respect to the electric component 101 in a state in which a portion of the first housing 11 is inserted into the arrangement portion 105 of the electric component 101 by inserting the positioning pin 21 into the positioning hole 109. The component fixing portions 15 fix the first housing 11 with respect to the electric component 101 by fastening the bolts 17 into the screw holes 107 via the collars 19.

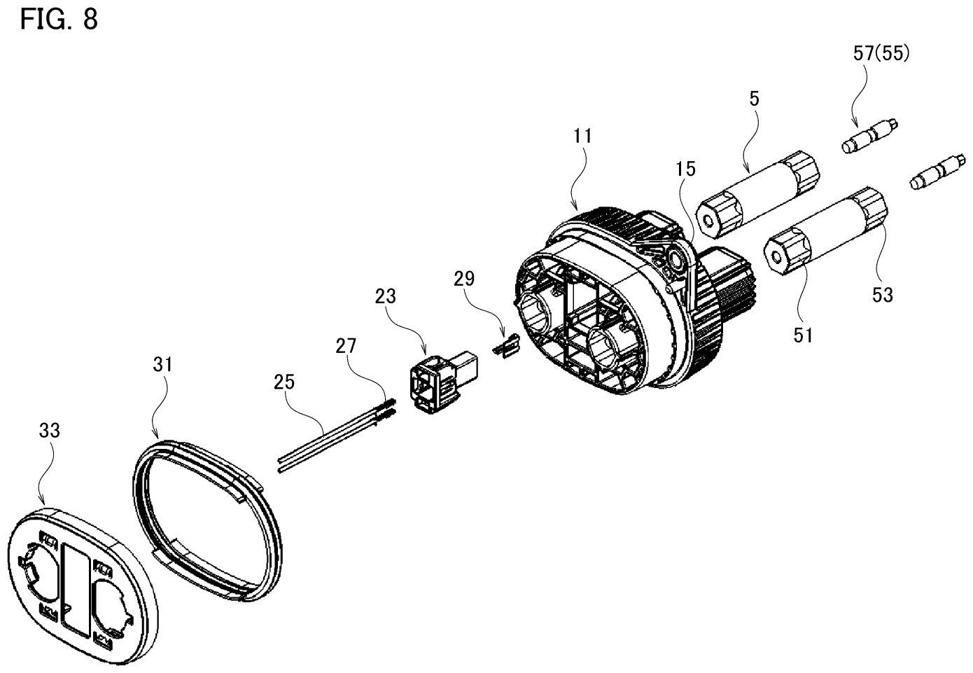

As illustrated in FIG. 8, an inner housing 23 is housed inside the first housing 11 from the electric component 101 side. The inner housing 23 is made of an insulating material such as synthetic resin, for example. The inner housing 23 is held inside the first housing 11 via engaging portions (not illustrated) that engage with each other. Inside the inner housing 23, for example, a plurality of signal terminals 27 (two in the embodiment) that are electrically connected to terminal portions of a plurality of signal wires 25 (two in the embodiment) that are electrically connected to the electric component 101 are housed. A terminal holder 29 that holds the signal terminals 27 therein is assembled to the inner housing 23. A locking lance that engages with the signal terminals 27 and holds the signal terminals 27 may be provided inside the inner housing 23. A packing 31 is closely assembled to the outer periphery of the first housing 11 on the electric component 101 side. The packing 31 is held in the first housing 11 by a front holder 33 that is assembled to the first housing 11 via engaging portions (not illustrated) that engage with each other. The packing 31 comes into close contact with the casing 103 of the electric component 101 in a state in which the first housing 11 is assembled to the electric component 101, and seals between the first housing 11 and the electric component 101. The plurality of first terminals 5 (two in the embodiment) are housed inside the first housing 11 from the side opposite to the electric component 101.

The second housing 13 is made of an insulating material such as synthetic resin, for example. As illustrated in FIGS. 1 to 6, 9, and 10, an upper portion of the second housing 13 is formed in a cylindrical shape in which a portion of the first housing 11 can be fitted therein, and a lower portion of the second housing 13 is formed in a cylindrical shape that communicates with the upper portion and extends in a direction orthogonal to the fitting direction of the first housing 11 and the second housing 13. The plurality of second terminals 7 (two in the embodiment) are inserted into the lower portion of the second housing 13 from below, and thus the plurality of second terminals 7 are housed in the upper portion of the second housing 13. At the outer periphery of the upper portion of the second housing 13, a plurality of component fixing portions 35 (two in the embodiment) projecting to an outer diameter side from the arrangement portion 105 of the electric component 101 are provided. In each component fixing portion 35, a collar 39 is insert-molded. Bolts 37 to be fastened into screw holes 111 that are provided in the casing 103 of the electric component 101 are inserted into the collars 39. The component fixing portions 35 fix the second housing 13 to the electric component 101 by fastening the bolts 37 into the screw holes 111 via the collars 39 in a state in which the first housing 11 and the second housing 13 are fitted with each other. The first housing 11 and the second housing 13 may be provided with engaging portions (not illustrated) that engage with each other, thereby maintaining a fitting state of the first housing 11 and the second housing 13.

A front packing 41 is closely assembled to the upper portion of the second housing 13 on the first housing 11 side. The front packing 41 is held in the second housing 13 by a front holder 43 that is assembled to the second housing 13 via engaging portions (not illustrated) that engage with each other. The front holder 43 has a plurality of holding pins 45 (two in the embodiment) projecting toward the second terminals 7 housed in the second housing 13. The front packing 41 is in close contact with the first housing 11 and seals between the first housing 11 and the second housing 13, in a state in which the first housing 11 and the second housing 13 are engaged with each other. A rear packing 47 is closely assembled to the upper portion of the second housing 13 on the cover 9 side. The rear packing 47 is held in the second housing 13 by a rear holder 49 that is assembled to the second housing 13 via engaging portions (not illustrated) that engage with each other. The rear packing 47 is in close contact with the cover 9 and seals between the second housing 13 and the cover 9, in a state in which the second housing 13 is covered by the cover 9.

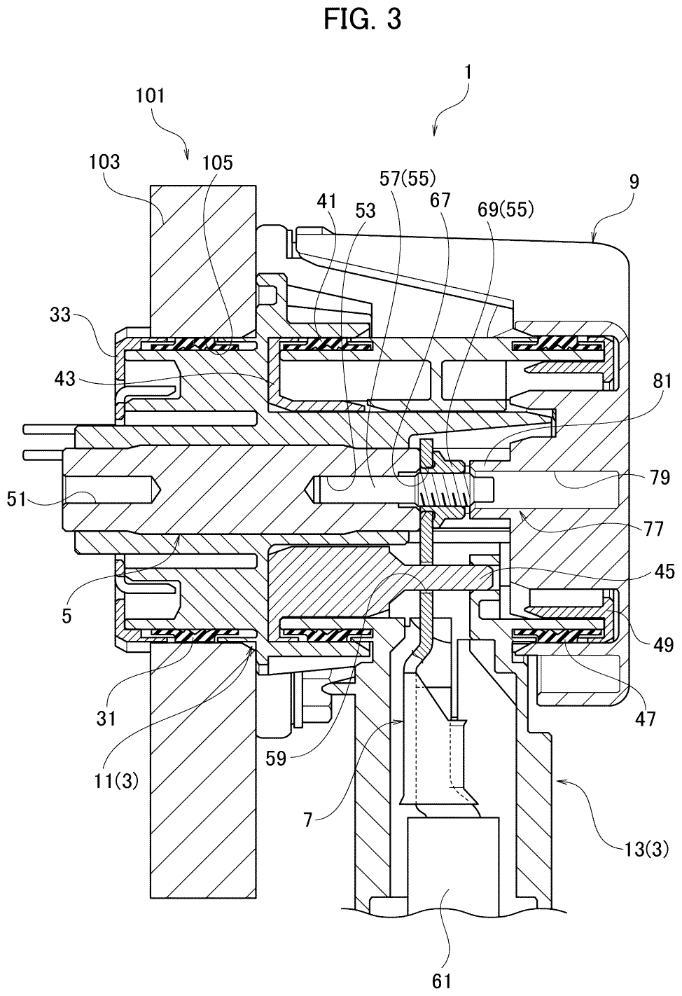

Each first terminal 5 is made of a conductive material and formed, for example, in a columnar shape. As illustrated in FIGS. 3, 5, and 8, The plurality of first terminals 5 (two in the embodiment) are housed in the first housing 11. An arrangement position of each first terminal 5 with respect to the first housing 11 is held by press-fitting, for example. A mating connection portion 51 and a terminal connection portion 53, which are formed of screw holes, are provided on both ends of each first terminal 5. A mating screw member (not illustrated) constituted of, for example, a stud bolt is fastened to the mating connection portion 51, and fixed integrally to each first terminal 5. A mating terminal of the electric component 101 is arranged in the mating screw member, and a mating nut (not illustrated) is fastened thereto. By fastening the mating nut to the mating screw member, the mating terminal and the first terminal 5 come into contact with each other, and thus the mating terminal and the first terminal 5 are electrically connected to each other.

Screw members 57 serving as fastening members 55 constituted of, for example, stud bolts are fastened to the terminal connection portions 53, and the screw members 57 are fixed integrally to the first terminals 5. By fixing the screw members 57 to the first terminals 5, each screw member 57 can be handled as one member with the corresponding first terminal 5, thereby reducing the number of components, and simplifying management and handling of the screw member 57. Incidentally, for example, the end portion of the first terminal 5 on the terminal connecting portion 53 side maybe formed in a columnar shape and the outer periphery of the columnar portion may be configured to have a screw shape, and thus the screw member 57 may be formed of one member continuous with the first terminal 5. The second terminal 7 is arranged in the screw member 57.

As illustrated in FIGS. 3, 5, and 10, each second terminal 7 is made of a conductive material, and is formed in a plate shape, for example. The plurality of second terminals 7 (two in the embodiment) are housed in the second housing 13. Each second terminal 7 is provided with a pin hole 59 that is formed by penetrating through the second terminal 7, and the holding pin 45 of the front holder 43 is inserted into the pin hole 59. The arrangement positions of the second terminals 7 with respect to the second housing 13 are held by inserting the holding pins 45 into the pin holes 59. The plurality of the second terminals 7 are electrically connected to the terminal portions of a plurality of electric wires 61 (two in the embodiment) which are electrically connected to other electric components (not illustrated) by crimping or welding, for example. A rubber plug 63 is closely assembled to the outer periphery of each electric wire 61 on the second terminal 7 side. The rubber plugs 63 are held in the second housing 13 by a lower holder 65 that is assembled to the second housing 13 via engaging portions (not illustrated) that engage with each other. The lower holder 65 is divided into two parts and assembled to the electric wires 61 via engaging portions (not illustrated) that engage with each other. By dividing the lower holder 65 in this way, the assembling position with respect to the electric wires 61 can be freely determined, thereby improving the assemblability. The rubber plugs 63 are in close contact with the second housing 13 and seal between the second housing 13 and the electric wires 61, in a state in which the second terminals 7 are housed in the second housing 13.

Each second terminal 7 is provided with an arrangement hole 67, which is formed by penetrating through the second terminal 7, at a position corresponding to the screw member 57 of the first terminal 5 in a state in which the first housing 11 and the second housing 13 are fitted with each other. A nut 69 as the fastening member 55 is arranged in the arrangement hole 67, and the nut 69 is rotatably and integrally assembled to the second terminal 7 by, for example, crimping. When the nut 69 is rotatably and integrally assembled to the second terminal 7, the nut 69 can be handled as one member with the second terminal 7, thereby reducing the number of components, and simplifying management and handling of the nut 69. In addition, when the nut 69 is rotatably assembled to the second terminal 7, the nut 69 can be fastened to the screw member 57 even though the screw member 57 is integrally provided to the first terminal 5. The nut 69 is arranged with a gap with respect to the outer surface of the second terminal 7, and can be inclined in a direction intersecting the axis of the screw member 57. Therefore, when the second terminal 7 is arranged to be inclined, the axis of the screw member 57 and the axis of the nut 69 can be arranged substantially on the same line due to inclination of the nut 69, and thus the nut 69 can be stably fastened to the screw member 57.

In the fastening member 55 including the screw member 57 and the nut 69, the nut 69 is arranged at the end portion of the screw member 57 in a state in which the first housing 11 and the second housing 13 are fitted with each other. At this time, when the screw member 57 and the nut 69 abut against each other and the second terminal 7 is inclined in a direction intersecting the axis of the screw member 57, the nut 69 is inclined in a direction intersecting the axis of the screw member 57. Due to the inclination of the nut 69, the axis of the screw member 57 and the axis of the nut 69 are arranged substantially on the same line, thereby absorbing the inclination of the second terminal 7. When the nut 69 is fastened to the screw member 57 in a state in which the nut 69 is arranged in the screw member 57, the first terminal 5 and the second terminal 7 are brought into contact with each other, and thus the first terminal 5 and the second terminal 7 are electrically connected to each other. The cover 9 is assembled to the portion of the second housing 13 where the fastening members 55 are positioned, which prevents the fastening members 55 from being exposed to the outside, thereby protecting the electrical connection portion between the first terminal 5 and the second terminal 7.

The cover 9 is made of an insulating material such as synthetic resin, for example. As illustrated in FIGS. 1 to 6, 11, and 12, the cover 9 covers the outer periphery of the upper portion of the second housing 13 on the side opposite to the electric component 101, and is formed in a shape capable of closing the opening of the second housing 13 where the fastening member 55 is positioned. At the outer periphery of the cover 9, a plurality of component fixing portions 71 (two in the embodiment) projecting to an outer diameter side from the arrangement portion 105 of the electric component 101 are provided at the same positions as the component fixing portions 35 of the second housing 13. In each component fixing portion 71, a collar 73 is insert-molded, and a bolt 37 to be fastened into a screw hole 111 that is provided in the casing 103 of the electric component 101 is inserted into the collar 73. The component fixing portions 71 fix the cover 9 to the electric component 101 by fastening the bolts 37 into the screw holes 111 via the collars 73 in a state in which the cover 9 covers the second housing 13. By providing the component fixing portions 71 at the same positions as the component fixing portions 35 of the second housing 13, the cover 9 can be fixed by the common bolts 37, thereby reducing the number of components. The second housing 13 and the cover 9 may be provided with engaging portions (not illustrated) that engage with each other, and thus the second housing 13 may be maintained to be covered by the cover 9. A short terminal 75 that electrically connects a plurality of signal terminals 27 (two in the embodiment) housed in the first housing 11 is housed in the cover 9, for example, by press-fitting. The short terminal 75 electrically connects the plurality of signal terminals 27 when the cover 9 is assembled to the electric component 101, and detects that the cover 9 is normally assembled to the electric component 101.

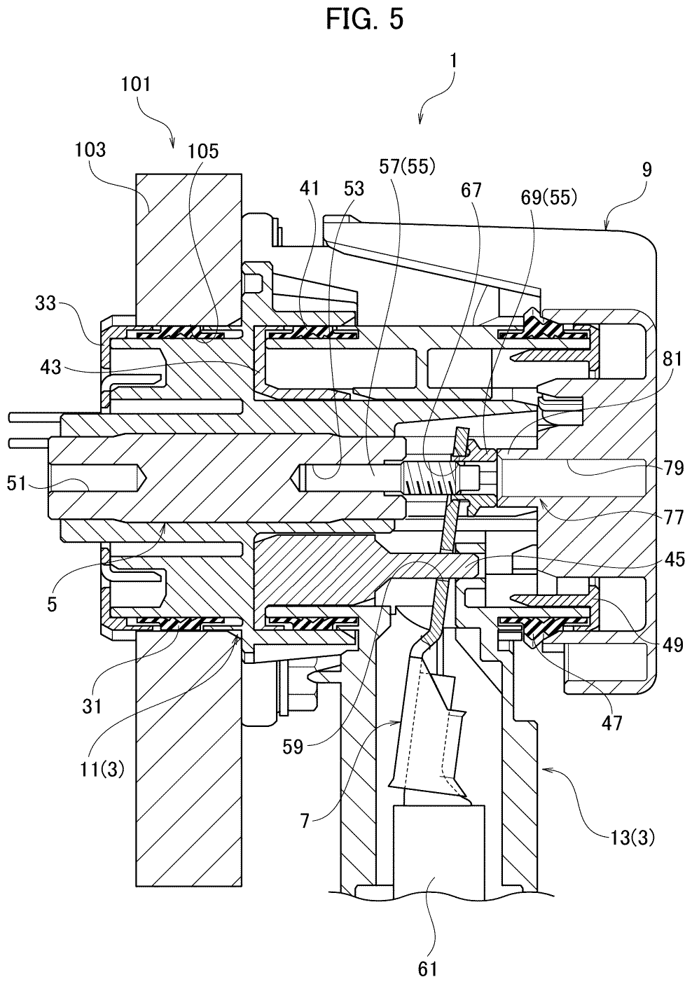

At the portions of the cover 9 facing the opening of the second housing 13 where the fastening members 55 are arranged, detection portions 77 are cylindrically extended toward the second housing 13 with one member continuous with the cover 9. The extending length of each detection portion 77 is set so as to be arranged apart from the nut 69 in a state in which the nut 69 is completely fastened to the screw member 57 and the cover 9 is assembled to the electric component 101 (see FIG. 3). A housing portion 79 in which the screw member 57 is housed is provided inside each detection portion 77 in a state in which the nut 69 is completely fastened to the screw member 57 and the cover 9 is assembled to the electric component 101. When the nut 69 is incompletely fastened to the screw member 57 and the cover 9 is assembled to the electric component 101 (see FIG. 5), the distal end side of the detection portion 77 in the extending direction is an abutment portion 81 that abuts against the nut 69.

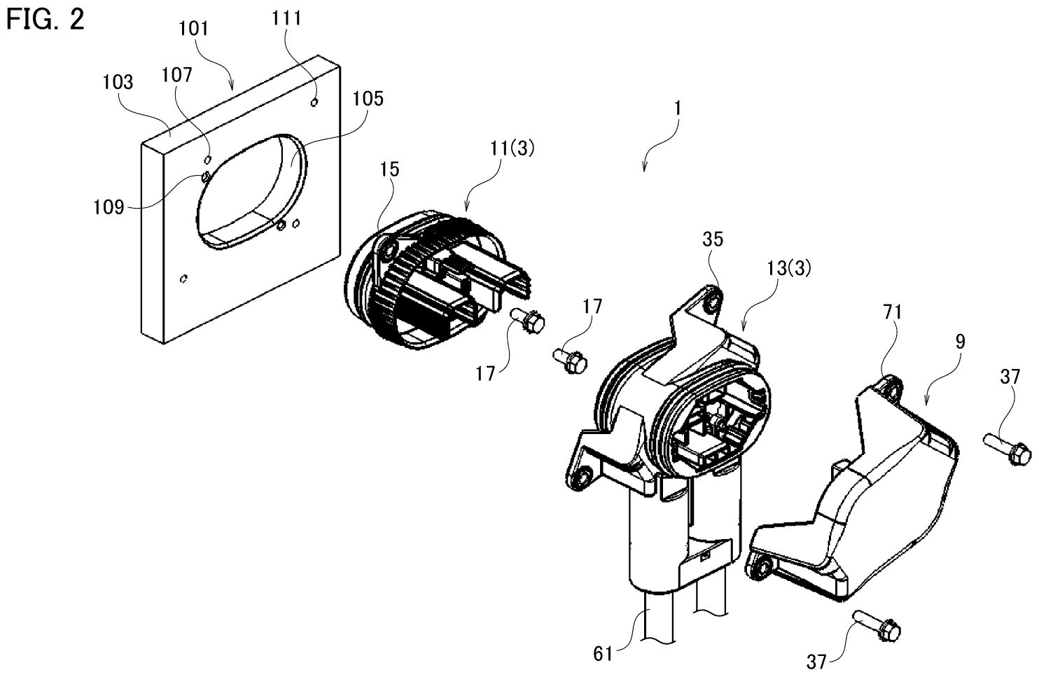

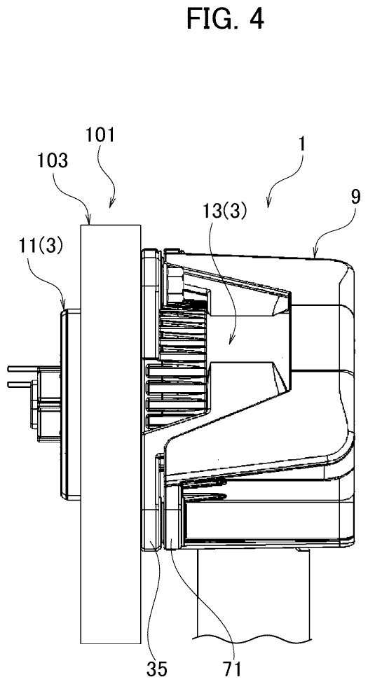

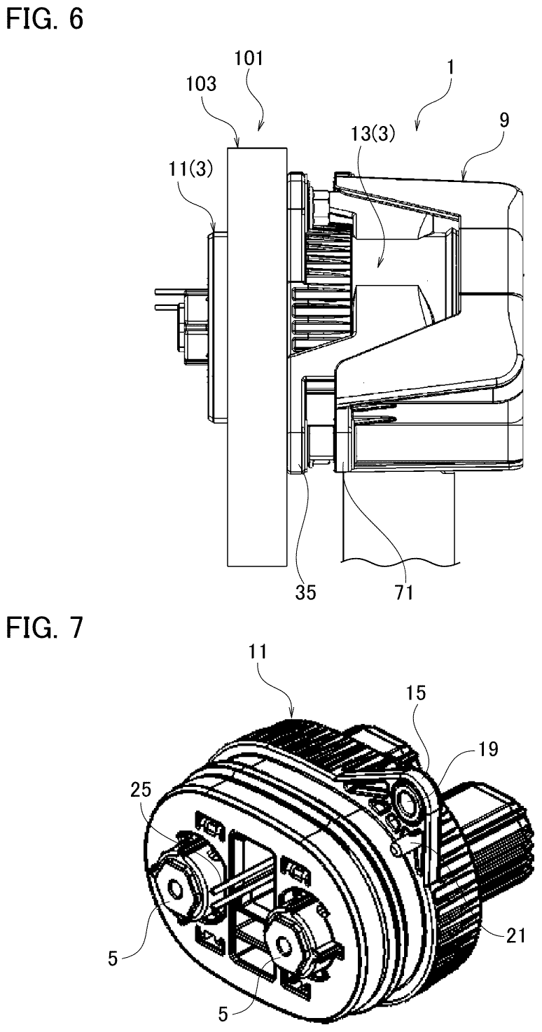

As illustrated in FIG. 3, in the detection portion 77, when the nut 69 is completely fastened to the screw member 57, the abutment portion 81 does not abut against the nut 69, and the distal end portion of the screw member 57 is housed in the housing portion 79. Therefore, as illustrated in FIG. 4, the cover 9 can be arranged to a position where the cover 9 can be fixed with the bolts 37 (see FIG. 2) with respect to the electric component 101, and thus the cover 9 can be assembled to the housing 3. Meanwhile, as illustrated in FIG. 5, in the detection portion 77, when the nut 69 is incompletely fastened to the screw member 57, the abutment portion 81 abuts against the nut 69. Therefore, as illustrated in FIG. 6, the cover 9 cannot be arranged to a position where the cover 9 can be fixed with the bolts 37 (see FIG. 2) with respect to the electric component 101, and thus the cover 9 cannot be assembled to the housing 3. Accordingly, the fastening state of the fastening member 55 (the nut 69) can be detected according to whether the cover 9 can be assembled to the housing 3. Thus, the fastening of the fastening member 55 is not incomplete, thereby maintaining the reliability of electrical connection.

First, the first housing 11, the second housing 13 and the cover 9 are assembled together as an example of the assembly of the connector 1 described above.

In the assembly of the first housing 11, first, the signal terminals 27 provided at the terminal portions of the signal lines 25 are housed in the inner housing 23, and the terminal holder 29 is assembled to the inner housing 23. Next, the inner housing 23 and the first terminals 5 are housed in the first housing 11. Next, the screw members 57 are fastened to the first terminals 5. The first terminals 5 to which the screw members 57 are fastened in advance may be housed in the first housing 11. Further, the packing 31 is mounted on the first housing 11, and the front holder 33 is assembled to the first housing 11, thereby completing the assembly of the first housing 11.

In the assembly of the second housing 13, first, the nuts 69 are assembled to the second terminals 7, and the second terminals 7 are assembled to the terminal portions of the electric wires 61 having the rubber plugs 63 mounted thereon. Next, the second terminals 7 are housed in the second housing 13, and the lower holder 65 is assembled to the second housing 13. Further, the front packing 41 and the rear packing 47 are mounted on the second housing 13, and the front holder 43 and the rear holder 49 are assembled to the second housing 13, thereby completing the assembly of the second housing 13.

In the assembly of the cover 9, the short terminal 75 is assembled to the cover 9, thereby completing the assembly of the cover 9.

In the assembly of the connector 1, first, the first housing 11 is arranged in the arrangement portion 105 of the electric component 101 such that the positioning pins 21 are inserted into the positioning holes 109. Next, the bolts 17 are inserted into the collars 19 of the component fixing portions 15 of the first housing 11, the bolts 17 are fastened into the screw holes 107, and thus the first housing 11 is assembled to the electric component 101. Next, the second housing 13 is arranged such that the first housing 11 is fitted into the upper portion of the second housing 13. Next, the nuts 69 are fastened to the screw members 57, thereby electrically connecting the first terminals 5 and the second terminals 7. Next, the cover 9 is assembled to the second housing 13. At this time, the cover 9 can be assembled when the fastening state of the fastening members 55 are complete, and the cover 9 cannot be assembled when the fastening state of the fastening members 55 are incomplete. Further, the bolts 37 are inserted into the collars 39 of the component fixing portions 35 of the second housing 13 and the collars 73 of the component fixing portions 71 of the cover 9, and the bolts 37 are fastened into the screw holes 111, thereby completing the assembly of the connector 1.

The connector 1 described above includes the housing 3, the first terminals 5 that are housed in the housing 3, and the second terminals 7 that are housed in the housing 3 and electrically connected to the first terminals 5. The connector 1 further includes the fastening members 55 that electrically connect the first terminals 5 and the second terminals 7 by fastening, and the cover 9 that is assembled to the housing 3 and covers a portion where the fastening members 55 is arranged. The cover 9 is provided with the detection portions 77 that abut against the fastening members 55 when the fastening members 55 are arranged at incomplete fastening positions, and prevent the cover 9 from being assembled to the housing 3.

When the fastening members 55 are completely fastened, the detection portions 77 do not abut against the fastening members 55, thereby assembling the cover 9 to the housing 3. In contrast, when the fastening members 55 are incompletely fastened, the detection portions 77 abut against the fastening members 55, and thus cannot assemble the cover 9 to the housing 3. Therefore, the fastening states of the fastening members 55 can be detected according to whether the cover 9 can be assembled to the housing 3. Thus, the fastening of the fastening members 55 is not incomplete, thereby maintaining the reliability of electrical connection.

Accordingly, the connector 1 described above makes it possible to maintain the reliability of electrical connection.

Further, each fastening member 55 has the screw member 57 that is integrally provided to either one of the first terminal 5 and the second terminal 7 (here, the first terminal 5), and the nut 69 that is rotatably and integrally assembled to the other thereof (here, the second terminal 7), and fastened to the screw member 57. Further, the detection portion 77 is arranged so as to abut against the nut 69 that is arranged at an incomplete fastening position.

Since the screw members 57 are integrally provided to the first terminals 5, the screw members 57 can be handled as one member with the first terminals 5. Therefore, the number of components can be reduced, and management and handling of the screw members 57 can be simplified. Since the nuts 69 are rotatably and integrally assembled to the second terminals 7, the nuts 69 can be handled as one member with the second terminals 7. Therefore, the number of components can be reduced, and management and handling of the nuts 69 can be simplified. Further, when the nuts 69 are rotatably assembled to the second terminals 7, the nuts 69 can be fastened to the screw members 57 even though the screw members 57 are integrally provided to the first terminals 5. When the detection portions 77 are arranged so as to abut against the nuts 69 that are arranged at the incomplete fastening positions, the fastening state of the nuts 69 to the screw members 57 can be detected according to whether the detection portions 77 and the nuts 69 can abut against each other. Although the present embodiment has been described as above, the present embodiment is not limited to the above description, and various modified examples can be made within a scope of the gist of the present embodiment.

For example, although the screw member 57 is provided integrally to the first terminal 5 and the nut 69 is rotatably and integrally assembled to the second terminal 7, the present embodiment is not limited thereto, and the screw member 57 may be provided integrally to the second terminal 7 and the nut 69 may be rotatably and integrally assembled to the first terminal 5. In this case, the detection portion 77 may be arranged so as to abut against the screw member 57 that is arranged at the incomplete fastening position.

Further, although the fastening member 55 has the screw member 57 and the nut 69, the present embodiment is not limited thereto, and the fastening member 55 may have only a screw member. In this case, the detection portion 77 may be arranged so as to abut against a screw member in the incomplete fastening state.

1. A connector, comprising:
a housing;
a first terminal housed in the housing;
a second terminal housed in the housing and electrically connected to the first terminal;
a fastening member electrically connecting the first terminal and the second terminal by fastening; and
a cover assembled to the housing and covering a portion where the fastening member is arranged, wherein
the cover is provided with a detection portion that abuts against the fastening member when the fastening member is arranged at an incomplete fastening position, and prevents the cover from being assembled to the housing.

2. The connector according to claim 1, wherein
the fastening member comprises a screw member integrally provided to either one of the first terminal and the second terminal, and a nut rotatably and integrally assembled to the other of the first terminal and the second terminal and fastened to the screw member, and
the detection portion is arranged so as to abut against either one of the nut and the screw member when the fastening member is arranged at the incomplete fastening position.
